(19) United States
(12) Patent Application Publication
(10) Pub. No.: US 2013/0041936 A1
(43) Pub. Date: Feb. 14, 2013

(54) INFORMATION PROCESSING APPARATUS AND METHOD FOR TESTING INFORMATION PROCESSING SYSTEM

(71) Applicants: Tomohiro Ohtake, Kawasaki (JP); Toshihiro Kodaka, Yokohama (JP); Haruyasu Ueda, Ichikawa (JP)

(72) Inventors: Tomohiro Ohtake, Kawasaki (JP); Toshihiro Kodaka, Yokohama (JP); Haruyasu Ueda, Ichikawa (JP)

(73) Assignee: FUJITSU Limited, Kawasaki-shi (JP)

(21) Appl. No.: 13/534,210

(22) Filed: Jun. 27, 2012

(30) Foreign Application Priority Data
Aug. 12, 2011 (JP) 2011-176566

(51) Int. Cl. G06F 15/16

(52) U.S. Cl. 709/203

(57) ABSTRACT

A transmission unit transmits two or more requests belonging to one session to a server apparatus, without resetting the state of server software between the requests (first transmission process). The transmission unit also transmits the two or more requests to the server apparatus while resetting the state of the server software between the requests (second transmission process). A check unit compares a first response received as a result of the first transmission process with a second response received as a result of the second transmission process, and checks based on the comparison result whether the two or more requests need to be processed by the same server apparatus.

### CROSS-REFERENCE TO RELATED APPLICATION

This application is based upon and claims the benefit of priority of the prior Japanese Patent Application No. 2011-176566, filed on Aug. 12, 2011, the entire contents of which are incorporated herein by reference.

### FIELD

The embodiments discussed herein relate to an information processing apparatus and a method for testing an information processing system.

### BACKGROUND

Client/server type information processing systems are widely used where a client apparatus transmits a request to a server apparatus over a network, and the server apparatus processes the request and transmits a response to the client apparatus over the network. One example of such information processing systems is a World Wide Web (WWW) system where a client apparatus transmits a Hypertext Transfer Protocol (HTTP) request to a server apparatus, and the server apparatus transmits an HTTP response to the client apparatus.

If the number of requests which are received per unit time in an information processing system increases, a single server apparatus may not be able to handle all of the requests because the server apparatus has a limited throughput. To deal with this problem, there is an information processing system where a plurality of server apparatuses is provided, so that requests are distributed over the plurality of server apparatuses which then process the received requests. For example, there is a relay apparatus called a load balancer, which receives requests from client apparatuses, and transfers the requests to server apparatuses with taking into account the load on each server apparatus.

There has been proposed a system where a plurality of servers is provided, and requests received on a website are classified into sharable requests which are allowed to be processed by any servers and non-sharable requests which are to be processed by specified servers. There has also been proposed a method in which a load balancer that distributes requests over a plurality of application servers extracts and stores session data included in responses received from the application servers, so as to allow the application servers to share the session data. Please see, for example, International Publication Pamphlet No. 03/063447 and Japanese Laid-open Patent Publication No. 2010-79523.

By the way, out of a variety of server software, which run on server apparatuses, some are designed to complete a series of interrelated processes by interacting with the same client apparatus a plurality of times. For example, there is server software which causes a server apparatus to search for items matching with the conditions requested by a client apparatus in response to a first request and present the search result, and then to update a database with respect to an item selected from the search result in response to a second request. With respect to one session corresponding to a series of interrelated processes, the server software repeats reception of a request from the client apparatus and transmission of a response to the client apparatus a plurality of times.

In the case of processing a first request and then a second request belonging to the same session, the server software may or may not use data (for example, processing result) regarding the first request, depending on the contents of the second request, in processing the second request. To use the data regarding the first request for processing the second request, the server software may write the data on a storage device (for example, Random Access Memory (RAM) or Hard Disk Drive (HDD)) of a server apparatus executing the server software. However, to store the data regarding the first request in the server apparatus changes the state of the server software, which may have an influence on processing of the second request.

Therefore, load balancing is performed, preferably in such a way that requests are distributed so that two or more requests that need to use previous data are processed by the same server apparatus. For example, a load balancer determines a request destination server apparatus on the basis of the contents of a request (for example, a file path specified by the request) and a session identifier (ID) included in the request. A feature of requests that need to be processed by the same server apparatus may be called stickiness.

When an information processing system where server software is installed on a plurality of server apparatuses is started to operate, a load balancing rule is set in the information processing system. However, in setting the rule, there is a problem in defining how to determine whether or not two or more requests need to be processed by the same server apparatus. If two or more requests that need to be processed by the same server apparatus are transferred to different server apparatuses, the requests may not be processed properly. On the other hand, if two or more requests that do not need to be processed by the same server apparatus are determined to be processed by the same server apparatus, the efficiency of the load balancing deteriorates.

### SUMMARY

According to an aspect, there is provided an information processing apparatus to be used for testing an information processing system including a plurality of server apparatuses that are capable of executing server software to process a request. The information processing apparatus includes: a transmitter configured to perform a first transmission process of transmitting two or more requests belonging to one session to a server apparatus that executes the server software, without resetting a state of the server software between the two or more requests, and perform a second transmission process of transmitting the two or more requests to a server apparatus that executes the server software while resetting the state of the server software between the two or more requests; and one or more processors configured to compare a first response received as a result of the first transmission process with a second response received as a result of the second transmission process, and check based on a comparison result whether the two or more requests need to be processed by a same server apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 illustrates an information processing system according to a second embodiment;

FIG. 3 is a block diagram illustrating example hardware components of a reverse proxy server;

FIG. 4 is a block diagram illustrating example software components according to the second embodiment;

FIG. 5 illustrates an example request storage table;

FIG. 6 illustrates an example response storage table;

FIG. 7 is a flowchart illustrating an example of a path check process;

FIG. 8 illustrates a first exemplary sequence of the path check process;

FIG. 9 is a flowchart illustrating a load balancing process;

FIG. 10 illustrates an exemplary sequence of the load balancing process;

FIG. 11 is a block diagram illustrating example software components according to a third embodiment;

FIG. 12 is a block diagram illustrating example software components according to a fourth embodiment;

FIG. 13 illustrates a second exemplary sequence of the path check process;

FIG. 14 is a block diagram illustrating example software components according to a fifth embodiment;

FIG. 15 illustrates an example of how to create a temporary rule at the time of server update; and

FIG. 16 is a flowchart illustrating a server update process.

### DESCRIPTION OF EMBODIMENTS

Several embodiments will be described below with reference to the accompanying drawings, wherein like reference numerals refer to like elements throughout.

### First Embodiment

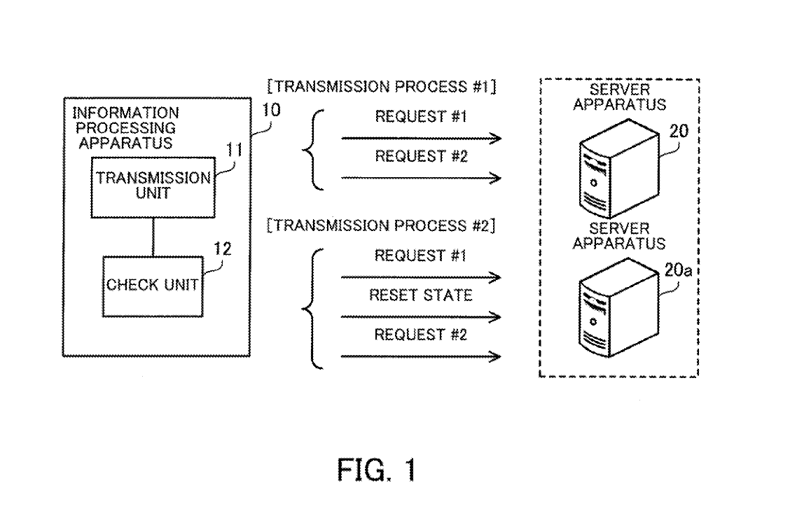

FIG. 1 illustrates an information processing apparatus according to a first embodiment. An information processing apparatus 10 is used for testing an information processing system including server apparatuses 20 and 20a. The server apparatuses 20 and 20a execute server software to process requests.

The information processing apparatus 10 and server apparatuses 20 and 20a are connected to each other over a network. The information processing apparatus 10 may be a client apparatus that makes requests, or a relay apparatus (for example, called a load balancer or a reverse proxy) that relays requests between client apparatuses and the server apparatus 20 and 20a. The information processing apparatus 10 may be provided with a processor such as a central processing unit (CPU) and a memory device such as a RAM, or may be a computer that executes a program stored in a memory device with a processor. The information processing apparatus 10 includes a transmission unit 11 and a check unit 12.

The transmission unit 11 performs both a first transmission process (transmission process #1) and a second transmission process (transmission process #2) on two or more requests that belong to one session. In the transmission process #1, the transmission unit 11 transmits the two or more requests to a server apparatus that executes server software, without resetting the state of the server software between the requests. In the transmission process #2, the transmission unit 11 transmits the two or more requests to a server apparatus that executes the server software while resetting the state of the server software between the requests. The transmission unit 11 may perform either the transmission process #1 or #2 first.

In the transmission process #1, the two or more requests are preferably transmitted to a single server apparatus (for example, server apparatus 20). In the transmission process #2, on the other hand, the two or more requests may be transmitted to a single server apparatus or may be distributed over two or more server apparatuses (for example, server apparatuses 20 and 20a). Alternatively, in the transmission process #2, the two or more requests may be distributed over two or more virtual server apparatuses (virtual machines) operating on one or more server apparatuses. Transmission destinations in the transmission processes #1 and #2 may be different. Requests may be HTTP requests, or may include a path to a requested file (for example, Uniform Resource Locator (URL) path).

The server apparatuses 20 and 20a reset the state of the server software by, for example, restoring (reverting) data stored in a storage area used by the server software in a storage device (for example, such as RAM or HDD) back to before a request was processed. To this end, the server apparatuses 20 and 20a save the data stored in the storage area before processing the request. The transmission unit 11 may instruct the transmission destination of requests to reset the state between the requests. For example, the transmission unit 11 may be designed to transmit a request #1 to the server apparatus 20, instruct the server apparatus 20 to reset the state, and then transmit a request #2 to the server apparatus 20.

The check unit 12 receives a first response (response #1) received as a result of the transmission process #1 and a second response (response #2) received as a result of the transmission process #2. As each of the responses #1 and #2, two or more responses may be received in response to two or more requests. The check unit 12 compares the responses #1 and #2 with each other, and checks based on the comparison result whether or not the two or more requests transmitted from the transmission unit 11 need to be processed by the same server apparatus. For example, in the case where the responses #1 and #2 have identical contents, the check unit 12 determines that the requests may be processed by different server apparatuses. In the case where the responses #1 and #2 have different contents, on the contrary, the check unit 12 determines that these requests need to be processed by the same server apparatus. Responses may be HTTP responses.

The check unit 12 may notify an administrator of the information processing system of the check result. In addition, the check unit 12 may create a load balancing rule on the basis of the check result, and store the rule in a relay apparatus (for example, a load balancer or reverse proxy). In the latter case, the check unit 12 extracts a path specified by the two or more requests transmitted from the transmission unit 11, and sets the extracted path as a path (sticky path) to be used for transferring a request to the same server as the previous request of the same session, in the rule.

According to the first embodiment, the information processing apparatus 10 transmits two or more requests belonging to one session to a server apparatus which executes server software, without resetting the state of the server software between the requests (transmission process #1). In addition, the information processing apparatus 10 transmits the two or more requests to a server apparatus which executes the server software while resetting the state of the server software between the requests (transmission process #2). The information processing apparatus 10 then compares a response #1 received as a result of the transmission process #1 with a response #2 received as a result of the transmission process #2, and checks based on the comparison result whether or not the two or more requests need to be processed by the same server apparatus. Therefore, the information processing apparatus 10 is capable of efficiently determining the load balancing rule for the information processing system including a plurality of server apparatuses.

For example, as a method for detecting a change in the state of server software (may be called a side effect), there is a method of monitoring data write to a storage device such as a RAM or HDD provided in the server apparatuses 20 and 20a. However, this method has a problem that modifications need to be made to individual server software, which involves making modifications to the server software and additionally installing monitoring software on the server apparatuses 20 and 20a, and therefore there is a problem with high test load. In addition, data to be written on a storage device of the server apparatuses 20 and 20a may just be temporary data, which is used while one request is processed and may not be used for processing subsequent requests (not a side effect). This may cause erroneous determination of stickiness. By contrast, the information processing apparatus 10 is capable of efficiently determining stickiness outside of the server apparatuses 20 and 20a.

Second to fifth embodiments, which will be described below, employ a WWW system in which files such as HyperText Markup Language (HTML) are transmitted over HTTP protocol from a server apparatus to a client apparatus. In this connection, the method according to the first embodiment may be applied to information processing systems other than the WWW system.

### Second Embodiment

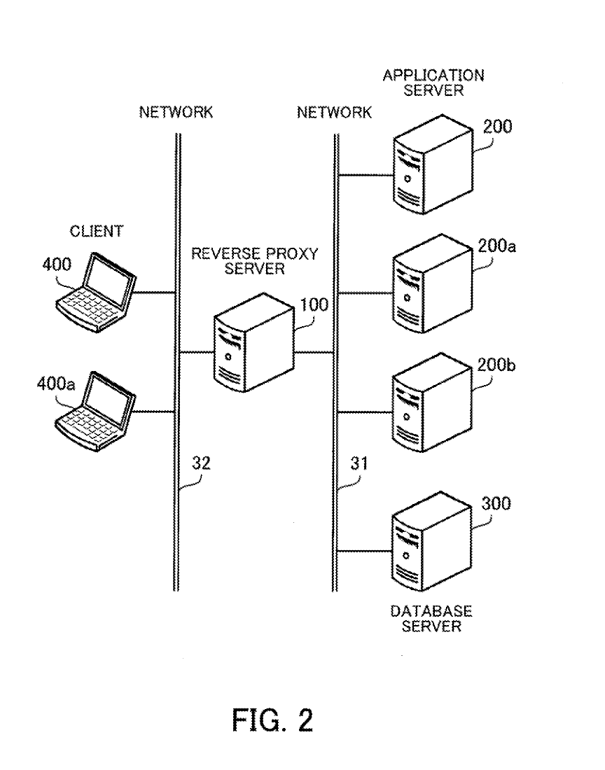

FIG. 2 illustrates an information processing system according to the second embodiment. This information processing system includes a reverse proxy server 100, application servers 200, 200a, and 200b, a database server 300, and clients 400 and 400a.

The reverse proxy server 100, application servers 200, 200a, and 200b, and database server 300 are connected to a network 31. The reverse proxy server 100 and clients 400 and 400a are connected to a network 32. The network 31 may be a Local Area Network (LAN), and the network 32 may be a wide-area network such as the Internet. In this connection, the application servers 200, 200a, and 200b, and clients 400 and 400a may be connected to the same network.

The reverse proxy server 100 is a server computer that operates as a load balancer and reverse proxy. The reverse proxy server 100 receives a request from the clients 400 and 400a, and transfers the request to any one of the application servers 200, 200a, and 200b. The reverse proxy server 100 also receives a response from the application servers 200, 200a, and 200b, and transfers the response to a client that is a destination specified by the response. For load balancing, the reverse proxy server 100 distributes received requests over the application servers 200, 200a, and 200b according to a rule set in the reverse proxy server 100.

The application servers 200, 200a, and 200b are server computers that execute server software (for example, Web application software) to process requests. The application servers 200, 200a, and 200b receive an HTTP request as a request, perform an appropriate process according to a path (for example, URL path) specified by the request, and transmit an HTTP response as a response. The application servers 200, 200a, and 200b may access the database server 300 for data read and update when processing requests.

The database server 300 is a server computer that executes a Database Management System (DBMS). The database server 300 stores data to be used by the application servers 200, 200a, and 200b in a non-volatile storage device, and reads or updates data according to accesses.

The clients 400 and 400a are client computers that execute client software (for example, Web browser) and issue requests, and, for example, are terminal devices that are operated by users or administrators of the information processing system. The clients 400 and 400a transmit HTTP requests as requests, and receive HTTP responses as responses. For example, an HTTP request includes a URL, and an HTTP response includes an HTML document. For example, the clients 400 and 400a display HTML documents included in HTTP responses (rendering).

A session ID is used for a series of HTTP communications performed by the same client. At the beginning of a session, the clients 400 and 400a transmit a request that does not include a session ID. When receiving the request without a session ID, the application servers 200, 200a, and 200b generate a new session ID, and transmit a response including the generated session ID. The clients 400 and 400a locally store the session ID included in the response and thereafter transmit requests including the stored session ID in the same session.

In load balancing, an application server for processing a request is selected on the basis of the path and session ID included in the request. A request distribution rule specifies sticky paths. The reverse proxy server 100 transfers a request to a certain application server if the request does not include a session ID. If the request specifies a non-sticky path, the request is transferred to a certain application server as well. In the case where a request includes a session ID and specifies a sticky path, the request is transferred to the same application server as the previous request belonging to the same session. It is because this request may need to be processed using data relating to the previous request.

A certain application server that is a transfer destination may be selected in a Round Robin manner. In addition, a transfer destination may be selected by weighting the frequency of transfer according to the throughputs and current loads of the application servers 200, 200a, and 200b.

To select the same application server as a previous request, the following method may be employed. First, the application servers 200, 200a, and 200b generate such a session ID as to make the application server identified by the reverse proxy server 100. For example, a letter for identifying an application server is added to the end of a session ID. As one example, “.a” is added to the end of a session ID for responses from the application server 200a, and “.b” is added to the end of a session ID for responses from the application server 200b. The reverse proxy server 100 identifies an application server which generated a session ID from the end of the session ID, and selects a transfer destination of the request. In this connection, this method is presented just as an example, and another method may be employed. For example, correspondences between the application servers 200, 200a, and 200b and session IDs may be stored in the reverse proxy server 100.

According to the second embodiment, in setting a load balancing rule, application software is tested by using the reverse proxy server 100, application server 200, and client 400 to determine sticky paths. The following describes how to set a load balancing rule.

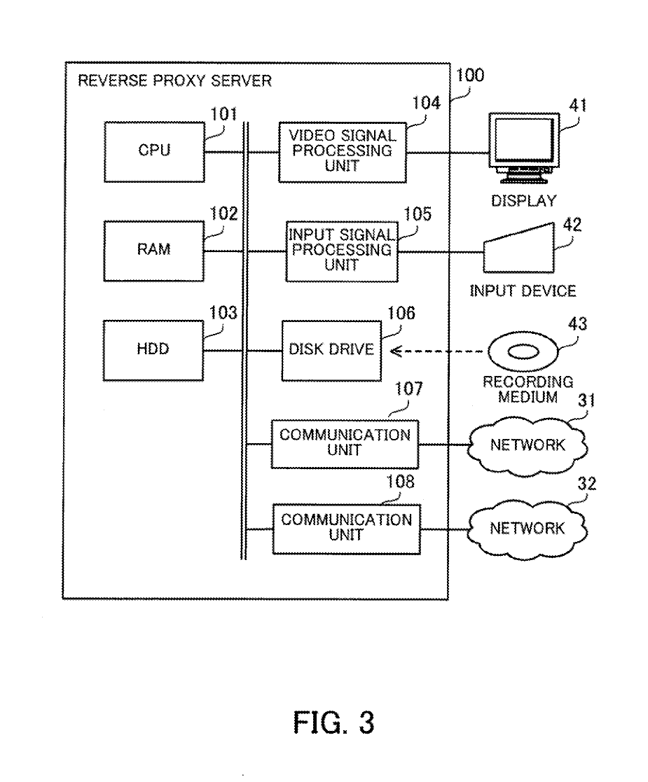

FIG. 3 is a block diagram illustrating example hardware components of a reverse proxy server. The reverse proxy server 100 includes a CPU 101, RAM 102, HDD 103, video signal processing unit 104, input signal processing unit 105, disk drive 106, and communication units 107 and 108. Each component is connected to a bus in the reverse proxy server 100. The application servers 200, 200a, and 200b, database server 300, and clients 400 and 400a may be designed to have the identical hardware components.

The CPU 101 is a processor that controls information processing of the reverse proxy server 100. The CPU 101 reads at least part of programs and data stored in the HDD 103, and executes the program by loading the program in the RAM 102. In this connection, a plurality of processors may be provided in the reverse proxy server 100 so that programs are distributed over and executed by the processors.

The RAM 102 is a volatile memory device that temporarily stores programs to be executed by the CPU 101 and data to be used while the programs run. In this connection, the reverse proxy server 100 may be provided with a variety of memory devices other than RAM, or with a plurality of memory devices.

The HDD 103 is a non-volatile storage device that stores programs such as operating system (OS) programs and application programs, and data. The HDD 103 performs data read and write on an internal magnetic disk under the control of the CPU 101. In this connection, the reverse proxy server 100 may be provided with a variety of non-volatile storage devices (for example, SSD) other than HDD, or with a plurality of storage devices.

The video signal processing unit 104 outputs images to a display 41 connected to the reverse proxy server 100 under the control of the CPU 101. The display may be a cathode ray tube (CRT) display or crystal liquid display, for example.

The input signal processing unit 105 receives input signals from an input device 42 connected to the reverse proxy server 100, and transfers the input signals to the CPU 101. The input device 42 may be a pointing device such as a mouse or touch panel, or a keyboard, for example.

The disk drive 106 is a drive device that reads programs and data from a recording medium 43. The recording medium 43 may be a magnetic disk such as a flexible disk (FD) or HDD, an optical disc such as compact disc (CD) or digital versatile disc (DVD), or a magneto-optical disk (MO). The disk drive 106 stores the program or data read from the recording medium 43 in the RAM 102 or HDD 103 under the control of the CPU 101.

The communication unit 107 is a communication interface for performing communications with the application servers 200, 200a, and 200b over the network 31. The communication unit 108 is a communication interface for performing communications with the clients 400 and 400a over the network 32. The communication units 107 and 108 may be wired or wireless communication interfaces. In this connection, the reverse proxy server 100 may be designed to have one communication interface in order to perform communications over the networks 31 and 32.

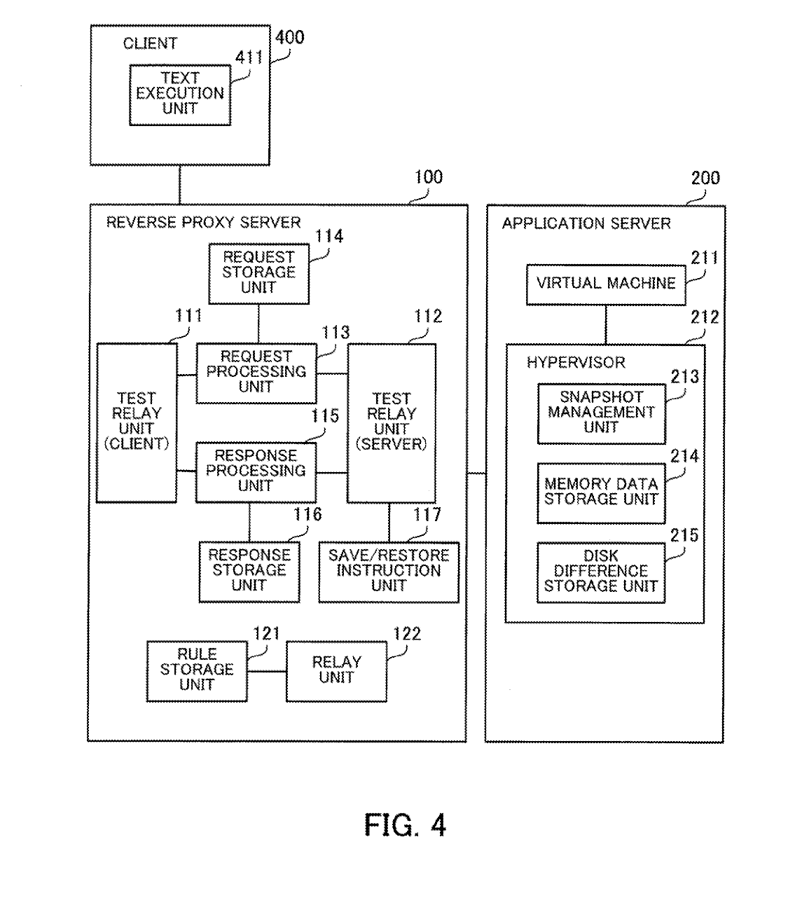

FIG. 4 is a block diagram illustrating example software components according to the second embodiment. Some or all of the components illustrated in FIG. 4 may be designed as program modules that are executed by the reverse proxy server 100, application server 200, or client 400. In addition, some or all of the components illustrated in FIG. 4 may be designed as electronic circuits such as Field Programmable Gate Array (FPGA) or Application Specific Integrated Circuit (ASIC).

The reverse proxy server 100 includes test relay units 111 and 112, a request processing unit 113, a request storage unit 114, a response processing unit 115, a response storage unit 116, a save/restore instruction unit 117, a rule storage unit 121, and a relay unit 122.

The test relay unit 111 performs communications regarding a test of server software with the client 400. The test relay unit 111 receives a request from the client 400, and outputs the received request to the request processing unit 113. The test relay unit 111 receives a response from the response processing unit 115 and transmits the received response to the client 400.

The test relay unit 112 performs communications regarding the test of server software with the application server 200. The test relay unit 112 receives a request from the request processing unit 113, and transmits the received request to the application server 200. In addition, the test relay unit 112 receives a response from the application server 200, and outputs the received response to the response processing unit 115. The test relay unit 112 also notifies the save/restore instruction unit 117 of a reception state of responses received from the application server 200.

In the first phase of the test, the request processing unit 113 receives a request from the test relay unit 111, stores the received request in the request storage unit 114, and also outputs the received request to the test relay unit 112. In addition, in the second phase of the test, the request processing unit 113 reads requests one by one in the order of storing the requests in the first phase, from the request storage unit 114, and outputs the read requests to the test relay unit 112.

The request storage unit 114 stores requests transmitted from the client 400, in the order of transmission. The request storage unit 114 may be a storage area prepared in the RAM 102 or HDD 103.

In the first phase of the test, the response processing unit 115 receives a response from the test relay unit 112, stores the received response in the response storage unit 116, and also outputs the received response to the test relay unit 111. In addition, in the second phase of the test, the response processing unit 115 receives a response from the test relay unit 112 and compares the received response with the response stored in the response storage unit 116 in the first phase. Then, the response processing unit 115 checks based on the comparison result whether a path specified by the requests is sticky or not. The response processing unit 115 reports the check result to the client 400.

The response storage unit 116 stores responses transmitted from the application server 200, in the order of transmission. The response storage unit 116 may be a storage area prepared in the RAM 102 or HDD 103.

The save/restore instruction unit 117 receives a command from the client 400, and controls the test of the server software. At the beginning of the first phase of the test, the save/restore instruction unit 117 transmits a command (save command) to generate a snapshot for the state of the server software to the application server 200. In addition, at the beginning of the second phase of the test and every time a response arrives in the second phase, the save/restore instruction unit 117 transmits a command (restore command) to restore the state of the server software to the application server 200.

The rule storage unit 121 stores a load balancing rule. The rule is determined and registered in the rule storage unit 121 by an administrator of the client 400, for example. The rule specifies sticky paths. The rule storage unit 121 may be a storage area prepared in the RAM 102 or HDD 103.

The relay unit 122 relays requests and responses regarding the server software that is running. The relay unit 122 receives a request from the clients 400 and 400a, and transfers the received request to any of the application servers 200, 200a, and 200b according to the rule stored in the rule storage unit 121. The relay unit 122 also receives a response from the application servers 200, 200a, and 200b, and transfers the received response to a destination client specified by the response.

The application server 200 operates one or more virtual machines by using a computer virtualization technique. The application server 200 includes a virtual machine 211 and hypervisor 212. The hypervisor 212 includes a snapshot management unit 213, a memory data storage unit 214, and a disk difference storage unit 215.

The virtual machine 211 is a virtual computer that executes server software (for example, Web application software). The application server 200 may operate a plurality of virtual machines, or may cause one or more virtual machines to execute a DBMS. Each virtual machine executes an OS, and performs specified processes with resources (the throughput of a CPU and the storage area of a RAM, etc.) allocated by the hypervisor 212.

The hypervisor 212 is control software for allocating resources to one or more virtual machines including the virtual machine 211 and managing the virtual machines.

The snapshot management unit 213 manages the snapshots of the virtual machine 211 that executes server software. When receiving a save command from the reverse proxy server 100, the snapshot management unit 213 saves the data of the virtual machine 211 that is stored in the RAM at the time of the receipt, in the memory data storage unit 214. In addition, the snapshot management unit 213 saves the data of the virtual machine 211 that is stored in the HDD at the time of the receipt, in the disk difference storage unit 215. In addition, when receiving a restore command from the reverse proxy server 100, the snapshot management unit 213 restores the data saved in the memory data storage unit 214 back to the RAM, and restores the data saved in the disk difference storage unit 215 back to the HDD (revert).

The memory data storage unit 214 stores the data (snapshot) of the virtual machine 211 that existed in the RAM at a certain time point. The memory data storage unit 214 may be a storage area prepared in the HDD, for example.

The disk difference storage unit 215 stores the data (snapshot) of the virtual machine 211 that existed in the HDD at a certain time point. The disk difference storage unit 215 may be a storage area prepared in the HDD, for example. In this connection, data to be managed by the disk difference storage unit 215 is a difference between the basic image data for virtual machines operating on the application server 200 and the disk data of the individual virtual machine 211. The application server 200 merges the basic image data and the differential data corresponding to the virtual machine 211 to thereby obtain the disk data of the virtual machine 211.

The client 400 includes a test execution unit 411.

The test execution unit 411 controls a test of server software in accordance with instructions from an administrator of the client 400. The test execution unit 411 transmits a command to begin the first phase of the test to the reverse proxy server 100. Then, the test execution unit 411 generates a series of two or more requests belonging to the same session as a test case, and sequentially transmits the two or more requests to the reverse proxy server 100. For example, the test execution unit 411 repeats transmission of one request and reception of one response corresponding to the request until transmission of all requests included in the test case is completed. In addition, the test execution unit 411 transmits a command to begin the second phase of the test to the reverse proxy server 100. The test execution unit 411 receives a path check result from the reverse proxy server 100, and displays the result on a display.

The reverse proxy server 100 according to the second embodiment is just an example of the information processing apparatus 10 of the first embodiment. The communication unit 107, or the test relay unit 112 and save/restore instruction unit 117 are an example of the transmission unit 11. The CPU 101 and RAM 102, or the response processing unit 115 is an example of the check unit 12.

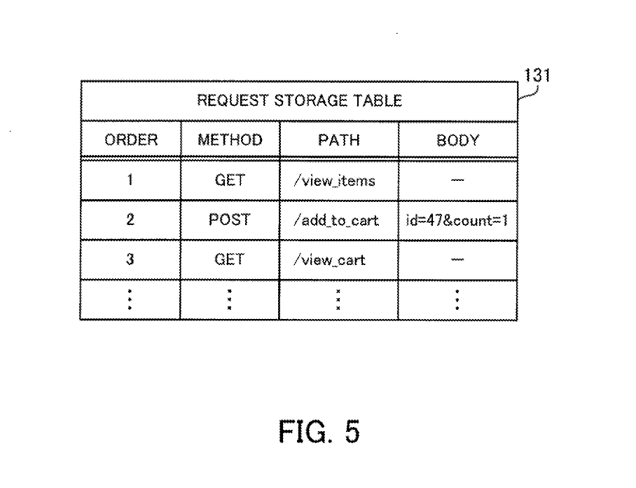

FIG. 5 is an example request storage table. The request storage table 131 is stored in the request storage unit 114 of the reverse proxy server 100. The request storage table 131 has fields for order, method, path, and body.

The order field contains a value (for example, sequential natural number) indicating the order of a request received from the client 400 in the first phase of a test. The method field contains the HTTP method included in a request. For example, “Method=GET” indicates a request for information specified by a URL. “Method=POST” indicates that data transmission from client software to server software is involved. The path field contains the path name in the URL included in a request. The body field contains the HTTP body included in a request. A request may not include a body.

A URL is defined by a host name including a scheme name corresponding to protocol and a domain name, and then a path name. A path specifies a file such as an HTML document, an image file, or a program file for generating an HTML document.

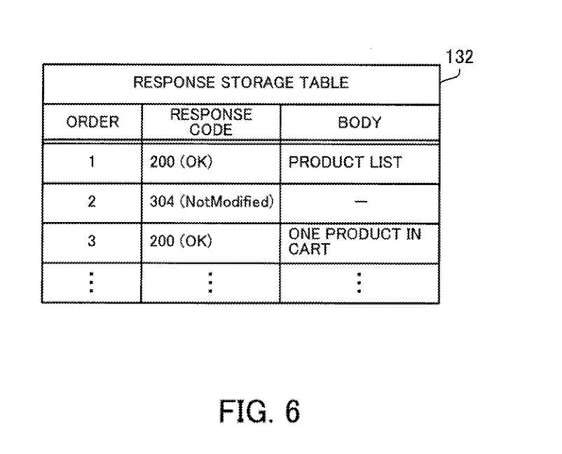

FIG. 6 illustrates an example response storage table. The response storage table 132 is stored in the response storage unit 116 of the reverse proxy server 100. The response storage table 132 includes fields for order, response code, and body.

The order field contains a value (for example, a sequential natural number) indicating the order of a response received from the application server 200 in the first phase of a test. The response code field contains the response code included in a response. A response code indicates how the response was processed by the server software. For example, “Response code=200” indicates that a request is successful, and is used as a response to “Method=GET”. “Response code=304” indicates that the body of a response does not change from a previous response, and is used as a response to “Method=POST”. The body field contains the HTTP body (for example, text of HTML document) included in a response. A response may not include a body.

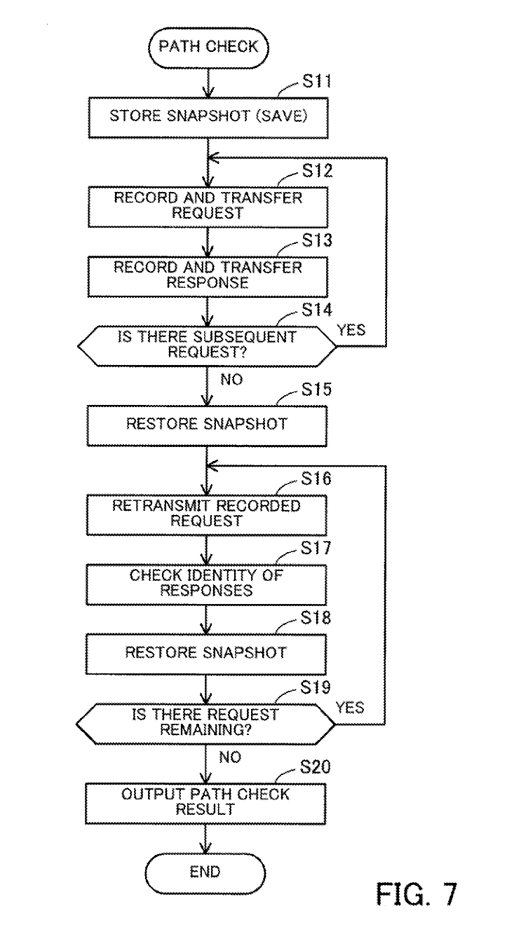

FIG. 7 is a flowchart illustrating an example of a path check process.

At step S11, the test execution unit 411 transmits a command to begin the first phase of a test to the reverse proxy server 100. The save/restore instruction unit 117 transmits a save command to the application server 200. The snapshot management unit 213 stores the data of the virtual machine 211 which exists in the RAM at the time of the reception of the save command, as a snapshot in the memory data storage unit 214. The snapshot management unit 213 also calculates a difference between the disk data of the HDD at the time of the reception of the save command and the basic image data, and stores the differential data as a snapshot in the disk difference storage unit 215.

At step S12, the test execution unit 411 transmits one request included in a test case to the reverse proxy server 100. The request processing unit 113 stores the received request in the request storage unit 114, and also transfers the request to the application server 200. The virtual machine 211 performs a process according to a path specified by the request received from the reverse proxy server 100, and transmits a response to the reverse proxy server 100. At this time, the virtual machine 211 may give a session ID to the response. In addition, the virtual machine 211 may use or update the session data stored in the RAM or HDD.

At step S13, the response processing unit 115 stores a response received from the application server 200 in the response storage unit 116. The response processing unit 115 also transfers the response to the client 400. The test execution unit 411 receives the response.

At step S14, the test execution unit 411 determines whether the test case includes a subsequent request or not. If there is a subsequent request, the test execution unit 411 makes the subsequent request belong to the same session as the previous request (for example, by including a session ID given from the application server 200 in the subsequent request), and then the process goes on to step S12. If there is no subsequent request, the process goes on to step S15.

At step S15, the test execution unit 411 transmits a command to begin the second phase of the test to the reverse proxy server 100. The save/restore instruction unit 117 transmits a restore command to the application server 200. The snapshot management unit 213 restores the data stored as a snapshot in the memory data storage unit 214, back to the RAM 102. The disk difference storage unit 215 restores the disk data of the HDD 103 by using the differential data stored as a snapshot in the disk difference storage unit 215. As a result, the state of the server software executed by the virtual machine 211 is reverted back to before the test case was executed.

At step S16, the request processing unit 113 extracts one request which was stored earlier, from the request storage unit 114, and re-transmits the request to the application server 200. The virtual machine 211 performs a process according to a path specified by the request received from the reverse proxy server 100, and transmits a response to the reverse proxy server 100.

At step S17, the response processing unit 115 extracts one response which was stored earlier, from the response storage unit 116, and compares the response with the response received from the application server 200. The response processing unit 115 checks identity of the contents of the two responses. For example, the response processing unit 115 determines that responses are identical if the responses are the same in terms of both response code and text of body, and determines that the responses are not identical if they are different in terms of at least one of the response code and text of body. Data other than response code and body may not be used for this identity check.

At step S18, when detecting reception of a response in the second phase, the save/restore instruction unit 117 transmits a restore command to the application server 200. The snapshot management unit 213 restores the data of the RAM 102 and the disk data of the HDD 103 by using snapshots stored in the memory data storage unit 214 and disk difference storage unit 215. As a result, the state of the server software is reverted back to before the request of step S16 was processed. In this connection, the check process (step S17) performed by the response processing unit 115 and the restore process (step S18) performed by the snapshot management unit 213 may be performed in a desired order or in parallel.

At step S19, the request processing unit 113 determines whether there is any request remaining in the request storage unit 114. If there is a remaining request, the process goes on to step S16. If there is no request remaining, the process goes on to step S20.

At step S20, the response processing unit 115 reports the path check result to the client 400. If it is determined at step S17 that at least one response is not identical to the corresponding one, the path specified by the two or more requests is determined as a sticky path.

If it is determined at step S17 that all responses are identical to the corresponding ones, the path specified by the two or more requests is determined as not a sticky path. The test execution unit 411 displays the path check result reported from the reverse proxy server 100 on a display connected to the client 400, for example. The administrator is able to determine a load balancing rule with reference to the path check result.

In the flow of FIG. 7, the process from steps 16 to S18 of the second phase is performed on all requests included in the test case. Alternatively, when it is determined at step S17 that a response is not identical to the corresponding one, the second phase may be terminated so as not to transmit subsequent requests to the application server 200.

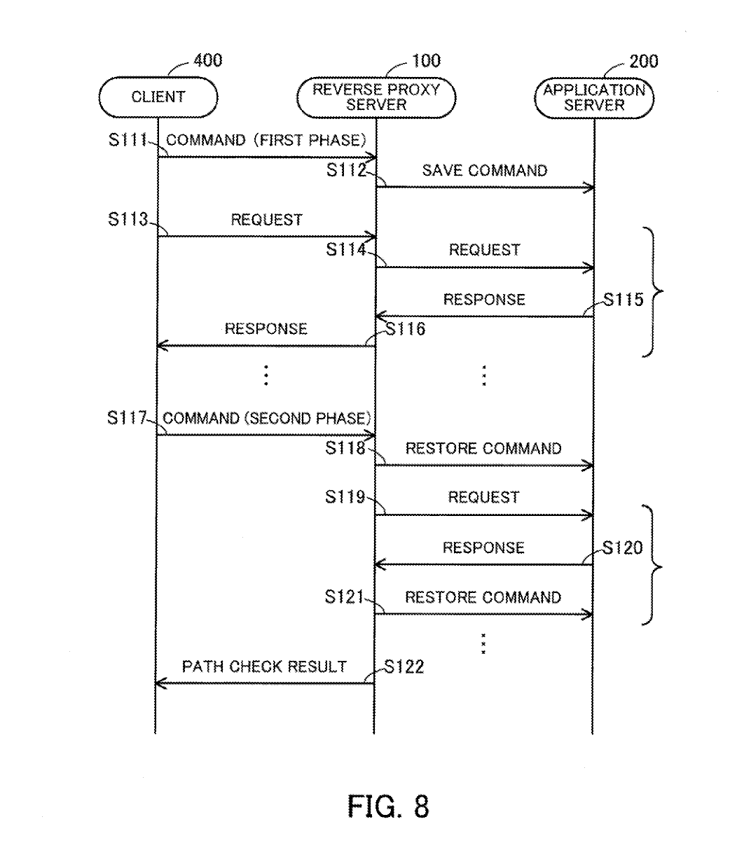

FIG. 8 illustrates a first exemplary sequence of a path check process.

The client 400 transmits a command to begin the first phase to the reverse proxy server 100 (step S111). The reverse proxy server 100 transmits a save command to the application server 200. The application server 200 stores a snapshot corresponding to the state of the server software before a test case is executed (step S112).

The client 400 transmits one request included in the test case to the reverse proxy server 100 (step S113). The reverse proxy server 100 stores the request, and transfers the request to the application server 200 (step S114). The application server 200 processes the request, and transmits a response to the reverse proxy server 100 (step S115). The reverse proxy server 100 stores the response, and also transfers the response to the client 400 (step S116). After that, a sequence of steps S113 to S116 is repeated as many times as the number of requests.

The client 400 transmits a command to begin the second phase to the reverse proxy server 100 (step S117). The reverse proxy server 100 transmits a restore command to the application server 200. The application server 200 reverts the state of the server software back to before the test case was executed (step S118).

The reverse proxy server 100 re-transmits one of the stored requests to the application server 200 (step S119). The application server 200 processes the request, and transmits a response to the reverse proxy server 100. The reverse proxy server 100 compares the response of the first phase with the response of the second phase to check the identity of the contents (step S120). The reverse proxy server 100 transmits a restore command to the application server 200. The application server 200 reverts the state of the server software back to before the request was processed (step S121). After that, a sequence of steps S119 to S121 is repeated as many times as the number of requests.

The reverse proxy server 100 reports to the client 400 on the path check result that indicates whether the path specified by the requests is sticky or not, on the basis of the identity of the responses checked at step S120 (step S122).

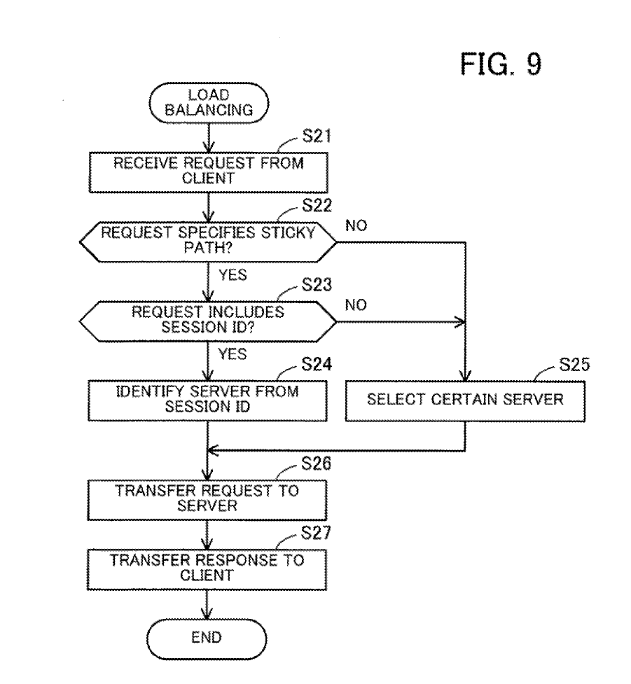

FIG. 9 is a flowchart illustrating a load balancing process. Assume now that, after a load balancing rule is set, requests transmitted from the client 400a are processed by the application servers 200a and 200b.

At step S21, the relay unit 122 receives a request from the client 400a.

At step S22, the relay unit 122 determines whether a URL path specified in the received request is registered as a sticky path in the rule stored in the rule storage unit 121. If the path is found, the process goes on to step S23. Otherwise, the process goes on to step S25.

At step S23, the relay unit 122 determines whether the received request includes a session ID or not. If the session ID is included, the process goes on to step S24. Otherwise, the process goes on to step S25. In this connection, JSESSIONID may be used as a session ID. A session ID may be added to a URL or may be inserted as a value of Cookie in an HTTP header, or inserted as a hidden item in the HTTP body.

At step S24, the relay unit 122 identifies a transfer destination application server from the session ID. For example, the relay unit 122 checks the end of the session ID, and determines that the application server 200a is a transfer destination if the end is “.a”, and that the application server 200b is a transfer destination if the end is “.b”. Then, the process goes on to step S26.

At step S25, the relay unit 122 selects an application server as the transfer destination of the request. For example, the relay unit 122 alternately selects the application servers 200a and 200b in a Round Robin manner. A selection algorithm may be set and stored as a rule in the rule storage unit 121.

At step S26, the relay unit 122 transfers the received request to the application server selected at step S24 or S25.

At step S27, the relay unit 122 receives a response from the application server selected as the transfer destination of the request, and transfers the response to the destination client.

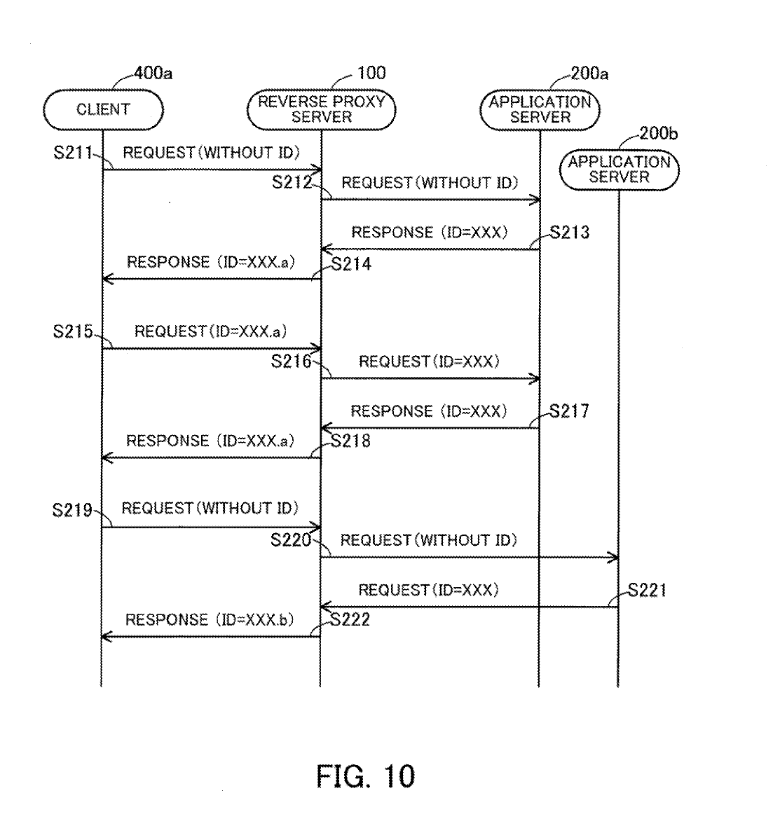

FIG. 10 illustrates an exemplary sequence of a load balancing process.

The client 400a transmits a request that does not include a session ID to the reverse proxy server 100 at the beginning of a session (step S211). The reverse proxy server 100 selects an application server (in the exemplary sequence of FIG. 10, application server 200a), and transfers the request (step S212).

The application server 200a generates a session ID=XXX, and performs a process according to a path specified by the request. In processing the request, data may be written in association with the session ID in the RAM or HDD of the application server 200a. The application server 200a transmits a response including the session ID=XXX to the reverse proxy server 100 (step S213). The reverse proxy server 100 transfers the response with the session ID rewritten to XXX.a to the client 400a (step S214).

The client 400a adds a session ID=XXX.a given at step S213 to a request belonging to the same session as step S211, and transmits the request to the reverse proxy server 100 (step S215). If the reverse proxy server 100 determines that the path specified by the request is a sticky path, selects the application server 200a on the basis of the end of the session ID, and transfers the request with the session ID rewritten to XXX (step S216).

The application server 200a performs a process according to the path specified by the request. In processing the request, data relating to session ID=XXX.a stored in the RAM or HDD of the application server 200a may be used or updated. The application server 200a transmits a response to the reverse proxy server 100 (step S217). The reverse proxy server 100 transfers the response to the client 400a (step S218).

The client 400a transmits a request that does not include a session ID, as a request belonging to a different session from step S211 or S215, to the reverse proxy server 100 (step S219). The reverse proxy server 100 selects an application server (in the exemplary sequence of FIG. 10, application server 200b), and transfers the request to the application server 200b (step S220).

The application server 200b generates a session ID=XXX, and performs a process according to a path specified by the request. In processing the request, data may be written in association with the session ID in the RAM or HDD of the application server 200b. The application server 200b transmits a response including the session ID=XXX to the reverse proxy server 100 (step 221). The reverse proxy server 100 transfers the response with the session ID rewritten to XXX.b to the client 400a (step S222).

According to the above-described second embodiment, to restore the state of the server software, the hypervisor 212 saves the snapshots of the virtual machine 211, and rewrites the data of the virtual machine 211 in the RAM and HDD at the time of restoration. Alternatively, the state of the server software may be restored with another method. For example, the application server 200 may be designed to save a directory used by the server software in a file system, and change a root directory recognized by the server software by using a chroot command at the time of restoration.

In the information processing system of the second embodiment, sticky paths to be registered in a load balancing rule are efficiently determined. As compared with a method of monitoring data write to the RAM or HDD of the application server 200, the method of the second embodiment reduces a test load, and improves reliability of the check process. In addition, the reverse proxy server 100 conducts a test between the application server 200 and the client 400, which results in efficient execution of the test without depending on specific server software or client software.

### Third Embodiment

The following describes a third embodiment. The description will focus on differential features from the second embodiment, and the same features as the second embodiment will not be explained again. In an information processing system according to the third embodiment, not a reverse proxy server but a client performs path check.

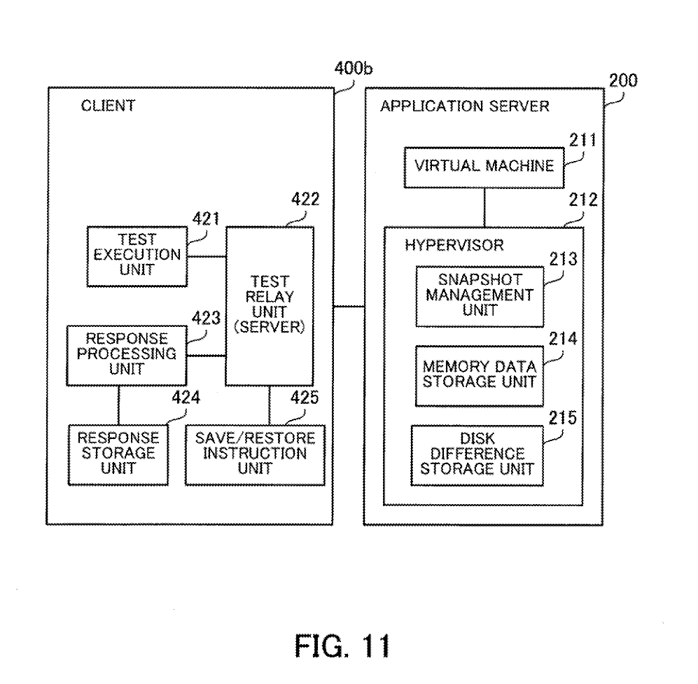

FIG. 11 is a block diagram illustrating example software components according to the third embodiment. A client 400b includes a test execution unit 421, a test relay unit 422, a response processing unit 423, a response storage unit 424, and a save/restore instruction unit 425. Some or all of the components of the client 400b illustrated in FIG. 11 may be designed as program modules to be executed by the client 400b, or as electronic circuits such as FPGA or ASCIC.

The test execution unit 421 controls a test of server software. The test execution unit 421 generates a series of two or more requests belonging to the same session as a test case. Then, in the first and second phases of the test, the test execution unit 421 sequentially outputs the generated two or more requests to the test relay unit 422.

The test relay unit 422 performs communications relating to the test of server software. The test relay unit 422 receives a request from the test execution unit 421, and transmits the received request to an application server 200. The test relay unit 422 also receives a response from the application server 200, and outputs the received response to the response processing unit 423.

In the first phase of the test, the response processing unit 423 receives a response from the test relay unit 422, and stores the received response in the response storage unit 424. In the second phase of the test, the response processing unit 423 also receives a response from the test relay unit 422, compares the received response with the response stored in the response storage unit 424, and checks based on the comparison result whether the path specified by the requests is sticky or not. The response processing unit 423 displays the check result on a display, for example.

The response storage unit 424 stores responses transmitted from the application server 200, in the order of transmission. The response storage unit 424 may be a storage area prepared in an RAM or HDD of the client 400b.

The save/restore instruction unit 425 transmits a save command to the application server 200 at the beginning of the first phase of a test. In addition, at the beginning of the second phase of the test and every time a response arrives in the second phase, the save/restore instruction unit 425 transmits a restore command to restore (revert) the state of the server software to the application server 200.

In this connection, the client 400b according to the third embodiment is an example of the information processing apparatus 10 of the first embodiment. A communication unit, or the test relay unit 422 and save/restore instruction unit 425 in the client 400b are one example of the transmission unit 11. A CPU and RAM, or the response processing unit 423 in the client 400b is one example of the check unit 12.

Similarly to the second embodiment, in the information processing system of the third embodiment, sticky paths to be registered in a load balancing rule are efficiently determined. In addition, in the third embodiment, the test is conducted without the necessity of modifying the reverse proxy server because the client 400b conducts the test. In this connection, referring to FIG. 11, a reverse proxy server may be designed to relay requests and responses between the application server 200 and client 400b. In addition, as described earlier, the application server 200 may be designed to restore the state of the server software by using a chroot command.

### Fourth Embodiment

The following describes the fourth embodiment. The description focuses on only different features from the second and third embodiments, and the same features as the second and third embodiments will not be explained again. An information processing system according to the fourth embodiment uses a plurality of virtual machines that operate on one or more application servers to execute the second phase of a test in parallel.

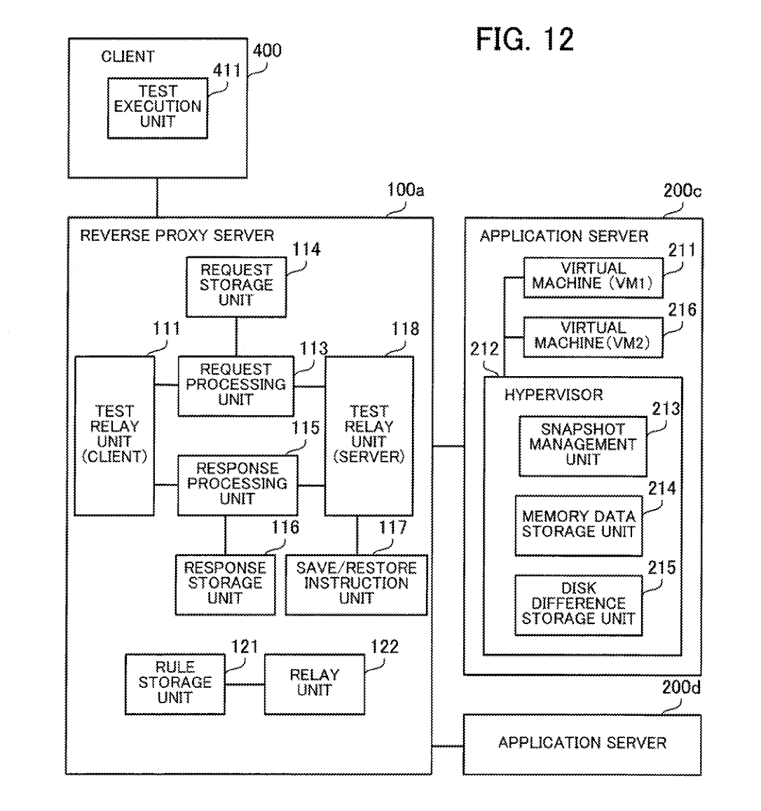

FIG. 12 is a block diagram illustrating example software components according to the fourth embodiment. Some or all of the components in a reverse proxy server 100a and application servers 200c and 200d illustrated in FIG. 12 may be program modules to be executed by servers or may be electronic circuits such as FPGA or ASIC.

The reverse proxy server 100a includes test relay units 111 and 118, a request processing unit 113, a request storage unit 114, a response processing unit 115, a response storage unit 116, a save/restore instruction unit 117, a rule storage unit 121, and a relay unit 122.

In the first phase of a test, the test relay unit 118 transmits a series of requests received from the request processing unit 113 to a single virtual machine operating on an application server (for example, application server 200c). In the second phase of the test, the test relay unit 118 distributes and transmits the series of requests received from the request processing unit 113 over a plurality of virtual machines operating on the application servers 200c and 200d. The test relay unit 118 also receives responses from the application servers 200c and 200d, and outputs the received responses to the response processing unit 115.

To distribute the requests in the second phase of the test, a Round Robin method may be employed. Alternatively, one virtual machine may be selected from among virtual machines whose states have been restored in response to a restore command (virtual machines which are available for a next request).

The application server 200c operates a plurality of virtual machines by using a computer visualization technique. The application server 200c includes virtual machines 211 and 216 and a hypervisor 212. Similarly, the application sever 200d is realized by using identical modules to the application server 200c.

The virtual machines 211 and 216 execute server software (for example, Web application software). The virtual machines 211 and 216 process requests received from the reverse proxy server 100a independently of the other virtual machines. The virtual machines 211 and 216 do not share the data of a session. The data of the virtual machines 211 and 216 stored in the RAM and HDD of the application server 200c is managed for each virtual machine by the hypervisor 212.

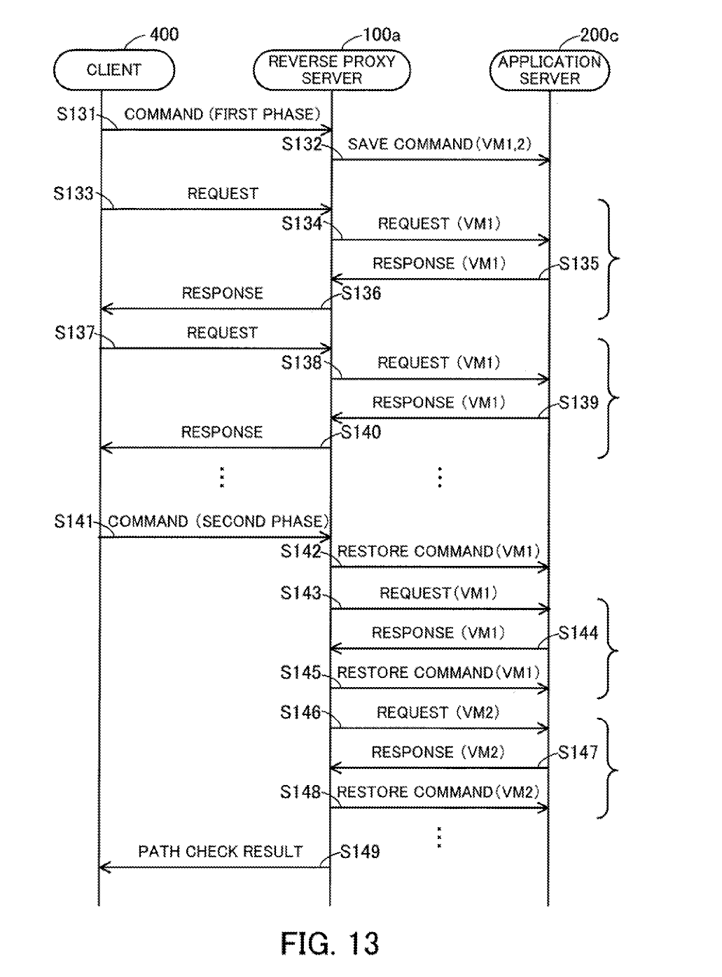

FIG. 13 illustrates a second exemplary sequence of a path check process.

The client 400 transmits a command to begin the first phase to the reverse proxy server 100a (step S131). The reverse proxy server 100a transmits a save command to the application serves 200c and 200d. The application server 200c stores the snapshots of the virtual machines 211 and 216 before executing a test case. The application server 200d performs a save process in the same way (step S132).

The client 400 transmits one of requests included in the test case to the reverse proxy server 100a (step S133). The reverse proxy server 100a transfers the request to the virtual machine 211 (step S134). The virtual machine 211 processes the request, and transmits a response to the reverse proxy server 100a (step S135). The reverse proxy server 100a transfers the response to the client 400 (step S136).

The client 400 transmits a request following the request of step S133 to the reverse proxy server 100a (step S137). The reverse proxy server 100a transfers the request to the virtual machine 211 that is the same destination as that of step S134 (step S138). The virtual machine 211 processes the request, and transmits a response to the reverse proxy server 100a (step S139). The reverse proxy server 100a transfers the response to the client 400 (step S140). In this way, requests are processed by the single virtual machine in the first phase.

The client 400 transmits a command to begin the second phase to the reverse proxy server 100a (step S141). The reverse proxy server 100a transmits a restore command to restore the state of the virtual machine 211 to the application server 200c. The application server 200c reverts the state of the virtual machine 211 back to before the test case was executed, by using snapshots (step S142).

The reverse proxy server 100a selects the virtual machine 211 out of the plurality of virtual machines, and transmits the request to the virtual machine 211 again (step S143). The virtual machine 211 processes the request, and transmits a response to the reverse proxy server 100a. The reverse proxy server 100a compares the response of the first phase with the response of the second phase to check the identity of their contents (step S144). The reverse proxy server 100a transmits a restore command to restore the state of the virtual machine 211 to the application server 200c. The application server 200c reverts the state of the virtual machine 211 back to before the request was processed by using snapshots (step S145).

The reverse proxy server 100a selects a virtual machine 216 that is different from the destination of step S143 out of the plurality of virtual machines, and transmits the request to the virtual machine 216 (step S146). The virtual machine 216 processes the request, and transmits a response to the reverse proxy server 100a. The reverse proxy server 100a compares the response of the first phase with the response of the second phase to check the identity of their contents (step S147). The reverse proxy server 100a transmits a restore command to restore the state of the virtual machine 216 to the application server 200c. The application server 200c reverts the state of the virtual machine 216 by using snapshots (step S148). In this way, the request is processed by using a plurality of virtual machines in the second phase.

The reverse proxy server 100a reports to the client 400 a path check result that indicates whether a path specified by the requests is sticky or not, on the basis of the identity of the responses checked at step S144 and 5147 (step S149).

Similarity to the second and third embodiments, in the information processing system of the fourth embodiment, sticky paths to be registered in the load balancing rule are efficiently determined. In addition, the fourth embodiment uses a plurality of virtual machines in the second phase of a test, so as to cause a certain virtual machine to process a request while another virtual machine is reverting. This makes it possible to reduce a waiting time for completion of reverting, and to reduce the test execution time. In this connection, as described earlier, the application server 200c may be designed to restore the states of the virtual machines 211 and 216 by using a chroot command.

### Fifth Embodiment

The following describes a fifth embodiment. The description focuses on only different features from the second to fourth embodiments, and the same features as the second to fourth embodiments will not be explained again.

An information processing system according to the fifth embodiment automatically creates a load balancing rule and applies the rule to a reverse proxy server so as to smoothly shift server software from old version to new version without interrupting the provision of services to clients.

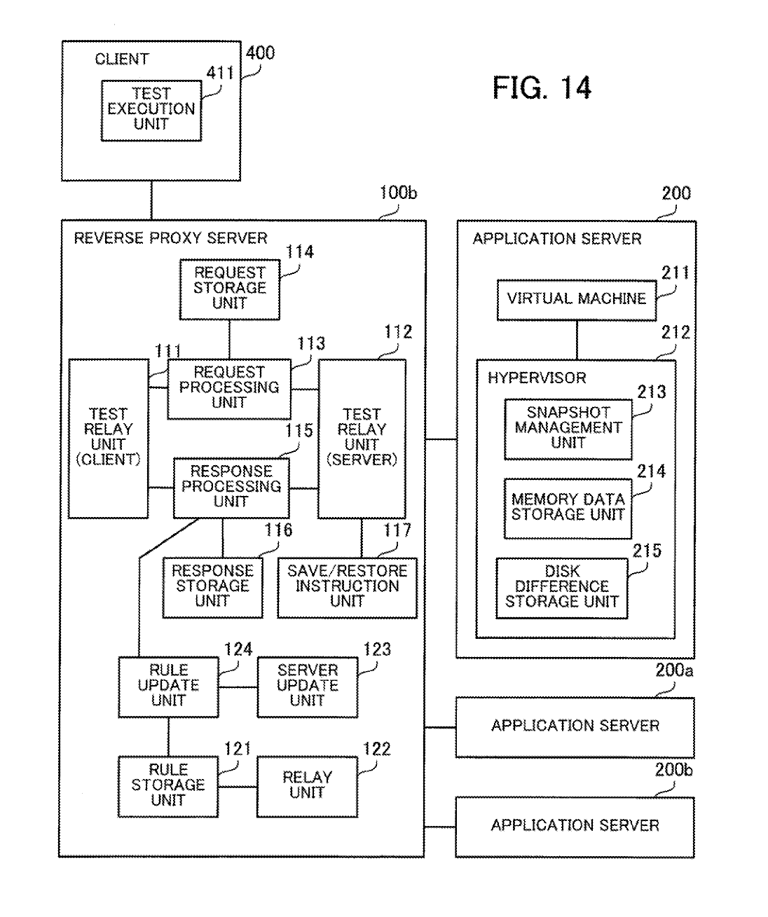

FIG. 14 is a block diagram illustrating example software components according to the fifth embodiment. A reverse proxy server 100b includes test relay units 111 and 112, a request processing unit 113, a request storage unit 114, a response processing unit 115, a response storage unit 116, a save/restore instruction unit 117, a rule storage unit 121, a relay unit 122, a server update unit 123, and a rule update unit 124. Some or all of the components in the reverse proxy server 100b may be program modules or electronic circuits such as FPGA or ASIC.

The server update unit 123 executes rolling update of server software. In the rolling update, application servers 200, 200a, and 200b are sequentially updated. For example, the server update unit 123 instructs the application server 200 to execute update, and after completion of the update, instructs the application server 200a to execute update. After completion of the update of the application server 200a, the server update unit 123 instructs the application server 200b to execute update. In this connection, the application server being updated is excluded from transfer destinations of requests.

The rule update unit 124 acquires a path check result for the server software of new version from the response processing unit 115, and creates a new rule specifying sticky paths. Then, on the basis of the new rule and old rule stored in the rule storage unit 121, a temporary rule to be applied during the rolling update is created. At the time of the beginning of the rolling update, the rule update unit 124 overwrites the old rule with the temporary rule in the rule storage unit 121, and after completion of the rolling update, the rule uprate unit 124 overwrites the temporary rule with the new rule in the rule storage unit 121.

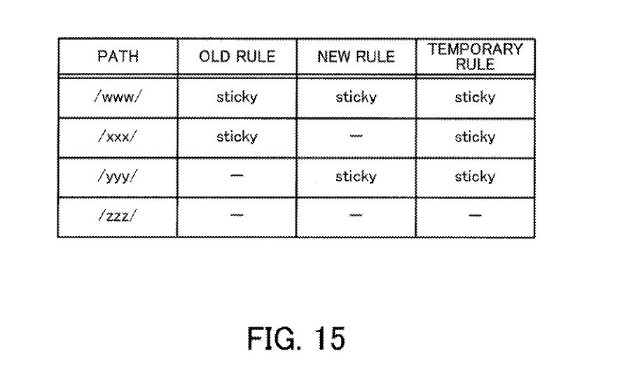

FIG. 15 illustrates an example of how to create a temporary rule at the time of server update.

A first path “/www/” is sticky in an old rule for server software of old version, and is also sticky in a new rule for server software of new version. A second path “/xxx/” is sticky in the old rule, but is not sticky in the new rule. A third path “/yyy/” is not sticky in the old rule, but is sticky in the new rule. The fourth path “/zzz/” is not sticky in either old or new rule.

When the rolling update is in progress, paths that are specified to be sticky in at least one of the old and new rules are treated to be sticky. Therefore, in the temporary rule, the first to third paths are treated to be sticky.

If the new rule is applied at the time of the beginning of the rolling update, a request specifying the second path may be transferred to an application server that is different from the previous request belonging to the same session. At this time, if the transfer destination application server is still executing the server software of old version, the request may not be processed properly. In addition, if the old rule is applied until completion of the rolling update, a request specifying the third path may be transferred to an application server that is different from the previous request belonging to the same session. At this time, if the destination application server has begun to use the server software of new version, the request may not be processed properly. Therefore, during the rolling update, both the second and third paths are treated to be sticky.

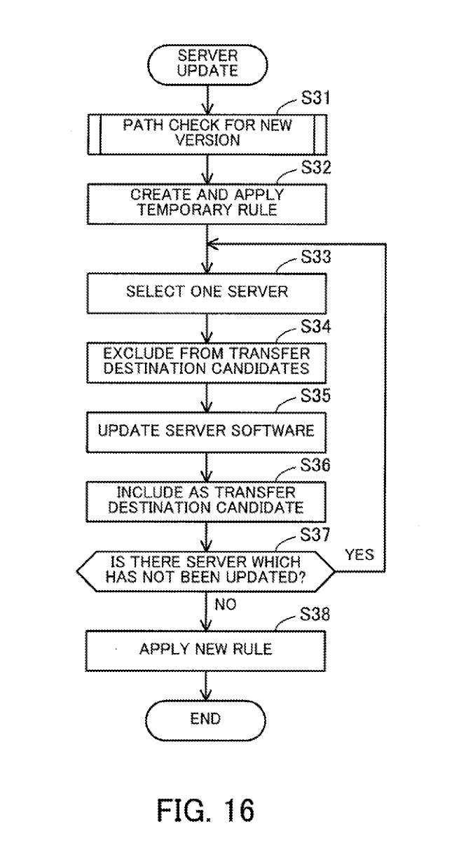

FIG. 16 is a flowchart illustrating a server update process.

At step S31, the response processing unit 115 determines sticky paths for server software of new version with the method described with reference to FIG. 7.

At step S32, the rule update unit 124 creates a new rule for load balancing on the basis of the check result obtained at step S31. On the basis of an old rule stored in the rule storage unit 121 and the created new rule, a temporary rule to be applied during the rolling update is created. The sticky paths specified in the temporary rule are a collection of paths specified by the new rule and the paths specified by the old rule. The rule update unit 124 writes the created temporary rule in the rule storage unit 121 to begin to apply the temporary rule.

At step S33, the server update unit 123 selects one application server that has not been updated from the application servers 200, 200a, and 200b.

At step S34, the relay unit 122 excludes the application server selected at step S33 from the request transfer destination candidates.

At step S35, the server update unit 123 instructs the application server selected at step S33 to update the server software. The virtual machine of the instructed application server stops the server software of old version, and reads and runs the program of the server software of new version. The server update unit 123 receives an update completion report from the application server.

At step S36, upon receipt of the update completion report, the relay unit 122 includes the application server selected at step S33 as a request transfer destination candidate again.

At step S37, the server update unit 123 determines whether there is an application server that has not been updated. If there is, the process goes on to the step S33. If there is not, the server update unit 123 determines that the rolling update is complete, and the process goes on to step S38.

At step S38, the rule update unit 124 writes the new rule created at step S32 in the rule storage unit 121, and begins to apply the new rule.

Similarly to the second to fourth embodiments, in the information processing system of the fifth embodiment, sticky paths to be registered in the load balancing rule are efficiently determined. In addition, in the fifth embodiment, the reverse proxy server 100b creates the temporary rule based on the old and new rules, and applies the temporary rule while the rolling update is in progress. This suppresses a trouble of failing to use data relating to previous requests, and the provision of services to the client 400 continues during the rolling update. In this connection, as described earlier, the application server 200 may be designed to restore the state of the virtual machine 211 by using a chroot command.

According to the above embodiments, a load balancing rule is determined for an information processing system including a plurality of server apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus to be used for testing an information processing system including a plurality of server apparatuses that are capable of executing server software to process a request, the information processing apparatus comprising:
a transmitter configured to perform a first transmission process of transmitting two or more requests belonging to one session to a server apparatus that executes the server software, without resetting a state of the server software between the two or more requests, and perform a second transmission process of transmitting the two or more requests to a server apparatus that executes the server software while resetting the state of the server software between the two or more requests; and
one or more processors configured to compare a first response received as a result of the first transmission process with a second response received as a result of the second transmission process, and check based on a comparison result whether the two or more requests need to be processed by a same server apparatus.

2. The information processing apparatus according to claim 1, wherein the transmitter instructs the server apparatus that executes the server software to restore data stored in a memory so as to reset the state of the server software.

3. The information processing apparatus according to claim 1, wherein, in the second transmission process, the transmitter distributes the two or more requests over two or more server apparatuses or two or more virtual server apparatuses operating on one or more server apparatuses.

4. The information processing apparatus according to claim 1, wherein the one or more processors register a file path specified by the two or more requests as a distribution rule to be referenced when requests are distributed over the plurality of server apparatuses, depending on a check result.

5. The information processing apparatus according to claim 4, wherein:
when the plurality of server apparatuses update first server software to second server software, the one or more processors check the second server software; and
the one or more processors create, on the basis of a first distribution rule for the first server software and a second distribution rule based on the check result, a third distribution rule to be applied while the first server software is updated to the second server software.

6. The information processing apparatus according to claim 1, wherein the information processing apparatus is a client apparatus that generates the two or more requests or a relay apparatus that relays the two or more requests between the client apparatus and the plurality of server apparatuses.

7. A method to be executed by a computer for testing an information processing system including a plurality of server apparatuses that are capable of executing server software to process requests, the method comprising:
performing a first transmission process of transmitting two or more requests belonging to one session to a server apparatus that executes the server software, without resetting a state of the server software between the requests;
performing a second transmission process of transmitting the two or more requests to a server apparatus that executes the server software while resetting the state of the server software between the requests; and
comparing a first response received as a result of the first transmission process with a second response received as a result of the second transmission process, and checking based on a comparison result whether the two or more requests need to be processed by a same server apparatus.

8. A computer-readable, non-transitory medium encoded with a computer program for testing an information processing system including a plurality of server apparatuses that are capable of executing server software to process requests, the computer program causing a computer to perform a procedure comprising:
performing a first transmission process of transmitting two or more requests belonging to one session to a server apparatus that executes the server software, without resetting a state of the server software between the requests;
performing a second transmission process of transmitting the two or more requests to a server apparatus that executes the server software while resetting the state of the server software between the requests; and
comparing a first response received as a result of the first transmission process with a second response received as a result of the second transmission process, and checking based on a comparison result whether the two or more requests need to be processed by a same server apparatus.
